(19) United States
(12) Patent Application Publication
(10) Pub. No.: US 2006/0063484 A1
(43) Pub. Date: Mar. 23, 2006

(54) Wireless local area network repeater with in-band control channel

(76) Inventors: James A. Proctor JR., Melbourne Beach, FL (US); Kenneth M. Gainey, Satellite Beach, FL (US)

Correspondence Address: POSZ LAW GROUP, PLC, 12040 SOUTH LAKES DRIVE, SUITE 101, RESTON, VA, 20191, US

(21) Appl. No.: 10/531,077

(22) PCT Filed: Oct. 24, 2003
(86) PCT No.: PCT/US03/31515

§ 371 Date: Apr. 12, 2005

Related U.S. Application Data
(60) Provisional application No. 60/420,449, filed on Oct. 24, 2002.

(51) Int. Cl. H04B 3/36

(52) U.S. Cl. 455/7

(57) ABSTRACT

A frequency translating repeater (200) for use in a WLAN environment includes an in-band management link. A signal received on an antenna (300) is split to provide signal detection in a detection and control unit (385) wherein detection is performed by detectors (370, 371) filters (375, 376), converters (380, 381) and a processor (385). Delay is added using delay lines (360, 361). The in-band signal envelope may be modulated with variable gain amplifier (330) and demodulated with detectors (370, 371) to establish the management link with higher protocol layer capability. Alternatively, a modern function at least partially compliant to 802.11 modulation may be used in parallel with the frequency translating repeater.

### CROSS REFERENCE TO RELATED APPLICATIONS

This application is related to and claims priority from pending U.S. Provisional Application No. 60/420,449 filed, Oct. 24, 2002, and is further related to PCT Application PCT/US03/16208 entitled WIRELESS LOCAL AREA NETWORK REPEATER, the contents of which are incorporated herein by reference.

### BACKGROUND OF THE INVENTION

The present invention relates generally to wireless local area networks (WLANs) and, particularly, the present invention relates to extending the coverage area associated with a WLAN repeater using an in band communication protocol to allow repeaters and other network devices to communicate information to each other for network management functions.

Several standard protocols for wireless local area networks, commonly referred to as WLANs, are becoming popular. These include protocols such as 802.11 (as set forth in the 802.11 wireless standards), IEEE802.16, IEEE802.20, home RF, and Bluetooth. The standard wireless protocol with the most commercial success to date is the 802.11b protocol although next generation protocols, such as 802.11g, are also gaining popularity.

While the specifications of products utilizing the above standard wireless protocols commonly indicate data rates on the order of, for example, 11 MBPS and ranges on the order of, for example, 100 meters, these performance levels are rarely, if ever, realized. Performance shortcomings between actual and specified performance levels have many causes including attenuation of the radiation paths of RF signals, which for 802.11b are in the range of 2.4 GHz in an operating environment such as an indoor environment. Access point to client ranges are generally less than the coverage range required in a typical home, and may be as little as 10 to 15 meters. Further, in structures having split floor plans, such as ranch style or two story homes, or those constructed of materials capable of attenuating RF signals, areas in which wireless coverage is needed may be physically separated by distances outside of the range of, for example, an 802.11 protocol based system. Attenuation problems may be exacerbated in the presence of interference in the operating band, such as interference from other 2.4 GHz devices or wideband interference with in-band energy. Still further, data rates of devices operating using the above standard wireless protocols are dependent on signal strength. As distances in the area of coverage increase, wireless system performance typically decreases. Lastly, the structure of the protocols themselves may affect the operational range.

Repeaters are commonly used in the mobile wireless industry to increase the range of wireless systems. However, problems and complications arise in that system receivers and transmitters may operate at the same frequency in a WLAN utilizing, for example, 802.11 WLAN or 802.16 WMAN wireless protocols. In such systems, when multiple transmitters operate simultaneously, as would be the case in repeater operation, difficulties arise. Typical WLAN protocols provide no defined receive and transmit periods and, thus, because random packets from each wireless network node are spontaneously generated and transmitted and are not temporally predictable, packet collisions may occur. Some remedies exist to address such difficulties, such as, for example, collision avoidance and random back-off protocols, which are used to avoid two or more nodes transmitting packets at the same time. Under 802.11 standard protocol, for example, a distributed coordination function (DCF) may be used for collision avoidance.

Such operation is significantly different than the operation of many other cellular repeater systems, such as those systems based on IS-136, IS-95 or IS-2000 standards, where the receive and transmit bands are separated by a deplexing frequency offset. Frequency division duplexing (FDD) operation simplifies repeater operation since conflicts associated with repeater operation, such as those arising in situations where the receiver and transmitter channels are on the same frequency for both the uplink and the downlink, are not present.

Other cellular mobile systems separate receive and transmit channels by time rather than by frequency and further utilize scheduled times for specific uplink/downlink transmissions. Such operation is commonly referred to as time division duplexing (TDD). Repeaters for these systems are more easily built, as the transmission and reception times are well known and are broadcast by a base station. Receivers and transmitters for these systems may be isolated by any number of means including physical separation, antenna patterns, or polarization isolation. Even for these systems, the cost and complexity of a repeater may be greatly reduced by not offering the known timing information that is broadcast, thus allowing for economically feasible repeaters.

Thus, WLAN repeaters have unique operating constraints due to the above spontaneous transmission capabilities and therefore require a unique solution. Since these repeaters use the same frequency for receive and transmit channels, some form of isolation must exist between the receive and transmit channels of the repeater. While some related systems such as, for example, CDMA systems used in wireless telephony, achieve channel isolation using sophisticated techniques such as directional antennas, physical separation of the receive and transmit antennas, or the like, such techniques are not practical for WLAN repeaters in many operating environments such as in the home where complicated hardware or lengthy cabling is not desirable or may be too costly.

One system, described in International Application No. PCT/US03/16208 and commonly owned by the assignee of the present application, resolves many of the above identified problems by providing a repeater which isolates receive and transmit channels using a frequency detection and translation method. The WLAN repeater described therein allows two WLAN units to communicate by translating packets associated with one device at a first frequency channel to a second frequency channel used by a second device. The direction associated with the translation or conversion, such as from the frequency associated with the first channel to the frequency associated with the second channel, or from the second channel to the first channel, depends upon a real time configuration of the repeater and the WLAN environment. The WLAN repeater may be configured to monitor both channels for transmissions and, when a transmission is detected, translate the received signal at the first frequency to the other channel, where it is transmitted at the second frequency.

The above described approach solves many of the issues and problems previously noted by monitoring and translating in response to packet transmissions and may further be implemented in a small inexpensive unit. However, while an exemplary architecture associated with the above frequency translating repeater adequately solves basic technical repeating problems, some important operational aspects, such as, for example, network management, remain unaddressed. Exemplary network management functions allowing, for example, for the configuration, monitoring, and detection of the presence of network elements may increase the usefulness of an exemplary repeater. Network management functions are particularly necessary in large scale networks deployed and managed by relatively centralized entities such as Multi-System Operator (MSOs) for example within the cable industry, Competitive Local Exchange Carriers (CLECs) within the telecommunications industry, or even in the business community, for example within an enterprise solution. Thus when repeater operation begins to fail or has failed, a network operator must quickly determine the presence and scope of the failure to prevent poor or failed performance in the network and hence improve customer dissatisfaction. Further, the presence of network management functionality allows targeted preventive maintenance to be performed as opposed to periodic reactive maintenance which is costly and disruptive. Network management functions may still further facilitate initial repeater configuration ensuring an exemplary frequency translating repeater is properly performing repeater functions, for example, on the correct channel, and at the correct power levels.

### SUMMARY OF THE INVENTION

Accordingly, in various exemplary and alternative exemplary embodiments, since the exemplary frequency translating repeater is suited for application within 802.11 WLAN environments, the exemplary frequency translating repeater may preferably include an 802.11 client. It will be appreciated that an 802.11 client refers to a WLAN node with protocol handling capability. By incorporating 802.11 client functionality within the frequency translating repeater which is preferably a physical layer or RF only repeater with no higher layer functionality, network management functions may be realized allowing, for example, the reception of 802.11 messages directly addressed to the repeater, and the transmission of messages directly to a managing node such as, for example, an Access Point (AP). An exemplary frequency translating repeater configured in accordance with various exemplary embodiments has the capability to communicate to 802.11 APs, and APs can communicate directly to frequency translating repeaters, for example, regarding management functions. In a situation where, for example, a full 802.11 station device is used to provide the exemplary maintenance link capability in the repeater, the RF components of the station device may be shared by the frequency translating repeater, including the Low Noise Amplifier (LNA), Power Amplifier (PA), the up/down converters, the filters, and the like. To further reduce the cost and complexity of such an implementation, a subset of the 802.11 client device may be included, eliminating additional unused components, such as including a subset of the 802.11 MAC protocol to simplify the complexity of the processing, or including support for only the minimum sets of modulations required to support the management features. This may include support for only the minimum data rates for instance, such as 1 and 2 MBPS for 802.11b and 802.11g, or only 6 MBPS for 802.11a. In this way, the repeater modem would not support a protocol or functionality that is compliant with the IEEE802.11 or other requirements, but would be able to interoperate with other devices that are compliant for the required subsets for the entire protocol. Alternatively, other standard client devices such as, for example, wireless modems known in the art by such names as Ultra-wideband, Bluetooth, HPNA or Home Plug 2, may be adapted for use in accordance with the invention.

One disadvantage associated with the implementation of an off-the-shelf, standards compliant 802.11 client within an exemplary frequency translating repeater is cost. The addition of an 802.11 client having additional hardware and software may drive the cost of the device too high for many applications. Therefore, a subset of the functionality integrated with the frequency translating repeater, for instance in a single integrated circuit, will mitigate this disadvantage.

Thus a preferred approach includes using the architecture of the frequency translating repeater described in detail, for example, in the above-referenced application, allowing for a low cost, low rate maintenance link. It should be noted that an exemplary frequency translating repeater in the form described in the referenced applications is typically non-regenerative; it does not provide any error correction or other protocol functions. Thus in accordance with one exemplary embodiment, a modem may be used in parallel with an exemplary frequency translating repeater to function as a wireless connection to overhead and control management from the network, which modem communicates to and from the control processor of the repeater. The use of a modem in parallel with the frequency translating repeater has the advantage that it may be more easily implemented and therefore has time-to-market advantages. A more integrated approach, where components enabling the modem functionality are shared with the repeater, and the modem itself is integrated with the repeater is preferred.

In accordance with various exemplary and alternative exemplary embodiments, capabilities already present in an exemplary frequency translating repeater are preferably used. It should be noted that a basic non-regenerative frequency translating repeater may be provided with sensitive channel power detectors used to detect channel activity as more fully described in the above-referenced patent application, as well as in a co-pending, commonly assigned International Patent Application No. PCT/US03/29130 entitled “WIRELESS LOCAL AREA NETWORK REPEATER WITH AUTOMATIC GAIN CONTROL FOR EXTENDING NETWORK COVERAGE”, filed Oct. 15, 2003, Attorney Docket Number 27-008 the contents of which are incorporated herein by reference.

Further in accordance with various exemplary and alternative exemplary embodiments, the present invention preferably uses channel detectors embedded in a receiver section of an exemplary frequency translating repeater to allow received signals to be demodulated using a form of amplitude modulation. Further, transmitter power control may be set by, for example, gain control to perform modulation of the transmitted amplitude further allowing a control link to be established from the repeater to a management node, such as an AP. Accordingly, no additional hardware is required to perform the management function and the basic repeating function. RF components such as the LNA, the PA, the up and/or down converters, the filters, and the like, are preferably shared between the repeater and the embedded client function.

### BRIEF DESCRIPTION OF THE DRAWINGS

FIG. 1 is a diagram illustrating a WLAN including an exemplary repeater environment in accordance with various exemplary embodiments.

FIG. 2 is a schematic drawing illustrating an exemplary frequency translating repeater and circuit for providing an in-band control channel.

FIG. 3 is a 802.11 or other standard or subset of the standard modem in parallel with the frequency translating repeater.

### DETAILED DESCRIPTION OF THE INVENTION

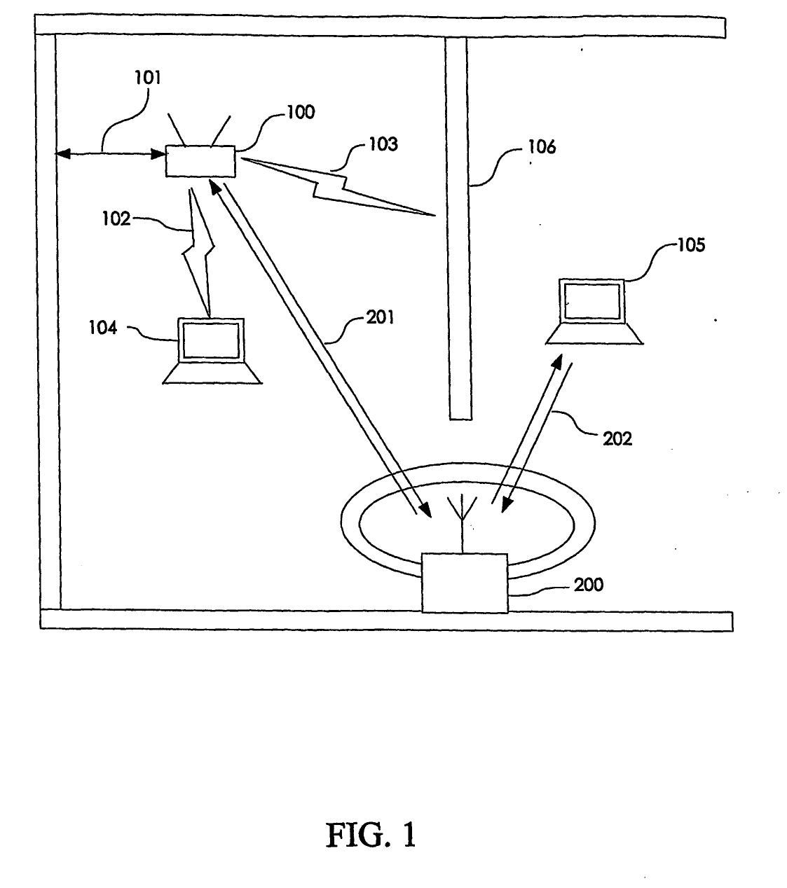

Referring now to FIG. 1, a wide area connection 101, which could be, for example, an Ethernet connection, a T1 line, a wideband wireless connection or any other electrical connection providing a data communications path, may be connected to a wireless gateway, or access point (AP) 100. The wireless gateway 100 sends RF signals, such as IEEE 802.11 packets or signals based upon Bluetooth, Hyperlan, or other wireless communication protocols, to client units 104, 105, which may be personal computers, personal digital assistants, or any other devices capable of communicating with other like devices through one of the above mentioned wireless protocols. Respective propagation, or RF, paths to each of the client units 104, 105 are shown as 102, 103.

While the signal carried over RF path 102 is of sufficient strength to maintain high-speed data packet communications between the client unit 104 and the wireless gateway 100, the signals carried over the RF path 103 and intended for the client unit 105 would be attenuated when passing through a structural barrier such as walls 106 or 107 to a point where few, if any, data packets are received in either direction if not for a wireless repeater 200, the structure and operation of which will now be described.

To enhance the coverage and/or communication data rate to the client unit 105, wireless repeater 200 receives packets transmitted on a first frequency channel 201 from the wireless gateway 100. The wireless repeater 200, which may be housed in an enclosure typically having dimensions of, for example, 2.5−×3.5−×0.5″, and which preferably is capable of being plugged into a standard electrical outlet and operating on 110 V AC power, detects the presence of a packet on the first frequency channel 201, receives the packet and re-transmits the packet with more power on a second frequency channel 202. Unlike conventional WLAN operating protocols, the client unit 105 operates on the second frequency channel, even though the wireless gateway 100 operates on the first frequency channel. To perform the return packet operation, the wireless repeater 200 detects the presence of a transmitted packet on the second frequency channel 202 from the client unit 105, receives the packet on the second frequency channel 202, and re-transmits the packet on the first frequency channel 201. The wireless gateway 100 then receives the packet on the first frequency channel 201. In this way, the wireless repeater 200 is capable of simultaneously receiving and transmitting signals as well as extending the coverage and performance of the wireless gateway 100 to the client unit 105.

To address the difficulties posed by obstructions as described above and attendant attenuation of the signal strength along obstructed paths and thus to enhance the coverage and/or communication data rate to client unit 105, exemplary wireless repeater 200, as shown in FIG. 1, may be used to retransmit packets beyond a range limited by propagation path constraints through, for example, frequency translation. Packets transmitted on a first frequency channel 201 from AP 100 are received at repeater 200 and re-transmitted, preferably with a greater power level, on a second frequency channel 202. Client unit 105 preferably operates on second frequency channel 202 as if AP 100 were also operating on it, such as with no knowledge that AP 100 is really operating on first frequency channel 201 such that the frequency translation is transparent. To perform return packet operations, repeater unit 200 detects the presence of a transmitted return packet on second frequency channel 202 from client unit 105, and is preferably configured to receive the packet on second frequency channel 202, and to retransmit the data packet to, for example AP 100, on first frequency channel 201.

Wireless repeater 200 is preferably capable of receiving two different frequencies simultaneously, such as first frequency channel 201 and second frequency channel 202 determining which channel is carrying a signal associated with, for example, the transmission of a packet, translating from the original frequency channel to an alternative frequency channel and retransmitting the frequency translated version of the received signal on the alternative channel. Details of internal repeater operation may be found in co-pending PCT Application No. PCT/US03/16208 the contents of which are incorporated herein by reference.

Repeater 200 may thus receive and transmit packets at the same time on different frequency channels thereby extending the coverage and performance of the connection between AP 100 and client unit 105, and between peer-to-peer connections such as from one client unit to another client unit. When many units are isolated from one another, repeater unit 200 further acts as a wireless bridge allowing two different groups of units to communicate where optimum RF propagation and coverage or, in many cases, any RF propagation and coverage was not previously possible.

In accordance with various exemplary embodiments, repeater 200 is preferably configured to receive a signal and translate the frequency of the received signal with very little distortion or loss of the signal. To further provide network management functions, in accordance with a first exemplary embodiment, repeater 200 may further be provided with client device functionality. It should be noted that the term “device” is used to describe functions which would be carried out by a device compliant with 802.11 protocols. In the context of the present invention, the “device” may be a virtual device, that is, the device may be realized in software with minimal additional hardware or may preferably include existing hardware adapted for the purposes of carrying out functions associated with the client device. Thus the client device is preferably integrated into repeater 200 and operates as further described herein below.

It will be appreciated that regardless of the exact implementation, an exemplary client device associated with the frequency translating receiver may operate as a distinctly identified and addressed device in the network. Specifically, the client device may operate as an independent node in the WLAN environment and may be addressed directly by network management devices such as APs or the like and may communicate with and control repeater 200 and may perform regenerative functions on data passing therethrough.

In accordance with another exemplary embodiment, a modem may be provided sharing signal detection hardware from repeater 200. In such a scenario, a control processor preferably functions as a demodulator using power detection circuitry allowing modulation associated with the exemplary management link to be based on modulating the amplitude of the transmitted or received signal, or in other words, provide the link in-band. If the same receiver and transmitter are to be shared, the control processor must be capable of transmitting FCC part 15.247 or part 15.407 compliant waveforms. Thus an AP, when sending a managment signal to repeater 200, may simply transmit a standard 802.11 signal with dummy information. At least part of the dummy waveform is identical to a standard 802.11 pre-amble with amplitude modulation performed on the 802.11 waveform. It should be noted that although no meaningful 802.11 data is in the 802.11 packet, the management information is communicated via the amplitude modulation on the dummy packet.

Alternatively, repeater 200 may transmit information associated with an exemplary maintenance or management link without necessarily receiving signals from the AP. A waveform in accordance with such an exemplary embodiment may be based on generating a modulated noise-like signal by amplifying an RF noise source such as a diode based noise generator, or other noise source at the noise floor of the signal which repeater 200 just re-transmitted, or other noise source well known to those skilled in the art.

In accordance with still another exemplary embodiment, repeater control processor may transmit an amplitude modulated additive white Gaussian noise (AWGN) signal intended to communicate with an 802.11 AP suitable enhanced for reception thereof; which AP has the ability to demodulate an AM signal. It will be appreciated that such modulation may be a type of amplitude modulation called on/off keying (OOK). In OOK, a signal is turned on and off to represent bit or symbol values, such as, for example, on to represent a 1 and off to represent a 0. OOK is popular for transmitting signals in environments where the symbol rate for the communication is much slower than the medium is capable of transmitting, such as, for example, in fiber optic cables. OOK modulation is considered to be a special case of Amplitude Shift Keying (ASK) modulation where no carrier or signal energy is present during the transmission of, for example, a zero. OOK modulation is also popular in control applications where simplicity and low implementation costs are of importance. It will further be appreciated that OOK modulation has the added advantage of allowing the transmitter to remain idle during the transmission of, for example, a zero, leading to reduced power consumption. It will be appreciated then that a transceiver section may be provided associated with the exemplary frequency translating repeater and exemplary client device, so as to receive and demodulate, and modulate and transmit signals associated with the management link.

It will be appreciated that in addition to a suitable modulation scheme for the exemplary management link, an appropriate line coding method is also needed. For example, a digital line coding method used in connection with OOK modulation must be a unipolar code. That is, the code must vary between a thresholded non zero vale and a zero value in contrast to other codes which are typically symmetric with respect to, for example, voltage. Some popular line codes suitable for use in accordance with various exemplary embodiments include, but are not limited to: unipolar non-return to zero (UNRZ), unipolar Return to zero (URZ), Offset Manchester Encoding, and the like.

Still another type of modulation scheme suitable for use in accordance with various exemplary embodiments, is pulse position modulation (PPM) called out, for example, in the 1999 version of the 802.11 specification, section 16, in connection with the infrared physical layer. PPM is a useful modulation scheme as it is very power efficient. Further, PPM fits well within the protocol framework since the higher layers of the protocol may be specified by the 802.11 link layer. Alternatively, protocol layers above modulation at the physical layer may be specified and adopted from another standard such as the IrDa specification.

Where 802.11 is used above the physical layer, a special timing synchronization pre-amble may be required associated with the management link, but only after a pre-amble conforming in duration to any standard 802.11 pre-amble being used in the same channel. The initial pre-amble preferably has no AM or OOK to allow, for example, the 802.11 distributed coordination function to operate correctly. Using the higher layers or at least a portion thereof adopted from 802.11, when repeater 200 transmits an OOK waveform associated with the management link, the MAC protocol would obey the 802.11 DCS procedures, allowing low impact to existing data traffic. Also, in accordance with 802.11 link layer specifications, the management link preferably operates in a positive acknowledgment mode.

Thus in accordance with various exemplary embodiments, the management link and the modulated signal thereon is being operated as a unique physical layer under 802.11 higher layers. Further, adoption of higher protocol layers from 802.11 within repeater 200 allows a known and effective addressing scheme to be incorporated thereinto, and many well established procedures for handling anomalies such as collisions and the like may further be incorporated thereinto.

It will be appreciated that the above described modem may be used to transmit and receive data between 802.11 or other station devices (STA) and/or APs also in communication with each other and used for data communications. When communicating between each other via repeater 200, standard 802.11 modulation may be used. Since repeater 200 is preferably non-regenerative; it does not demodulate the repeated 802.11 waveforms and thus has no access to the information within the repeated 802.11 packets, the management link is needed. Thus when, for example, an AP, for example, an 802.11 AP desires to communicate directly with repeater 200 rather than a STA device, the control link with OOK modulation may be used. Messages bound for repeater 200, as with standard 802.11 packet format, may include a MAC address of the repeater or in the case of a return message from repeater 200, the MAC address of the AP. Messages may include information used for node identification, initial configuration, modifications to the current configuration, and performance monitoring information.

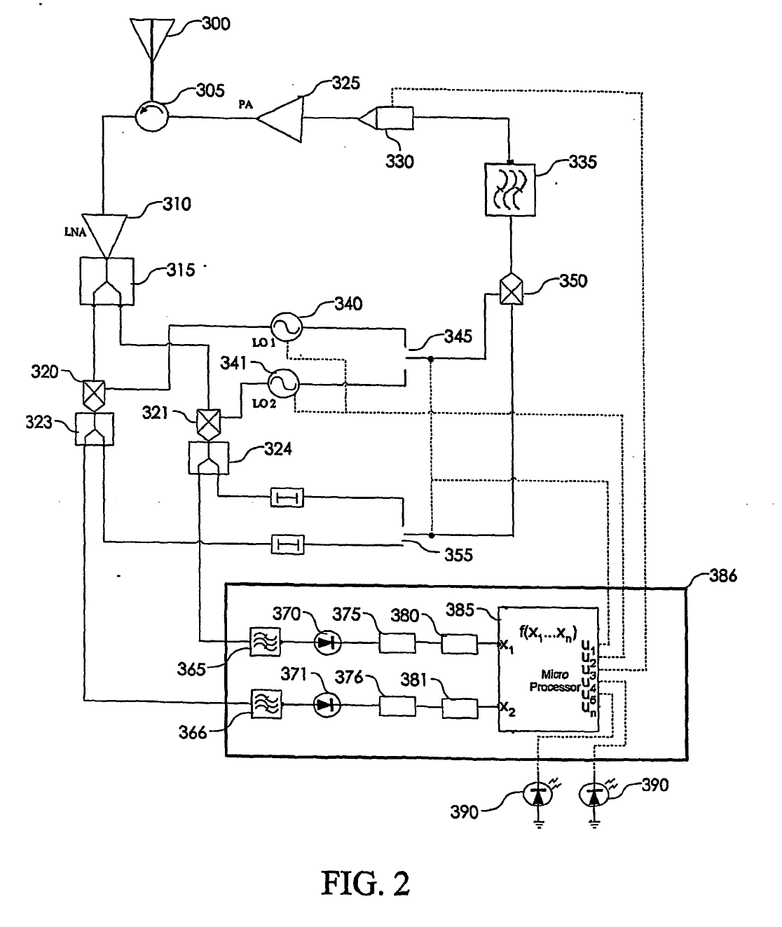

In accordance with various exemplary embodiments repeater 200, a detailed schematic of which is shown in FIG. 2, is preferably capable of receiving at least two different frequencies simultaneously, determining which one contains activity, translating the frequency of the active frequency to the one of the other frequencies and retransmitting a frequency translated version of the received signal. Features of the exemplary repeater include its ability to receive a signal and translate the frequency of the received signal with very little distortion due to fast signal detection and delaying the received signal long enough to determine proper control actions as described more fully in the above referenced International Patent Application No. PCT/US03/29130.

In accordance with various exemplary and alternative exemplary embodiments of the present invention, RF signals propagate from various wireless devices, such as an AP or the like, become incident to element 300 which element is an antenna or like electromagnetic transducer configured to receive the energy from the propagating signal and eventually convert the signal energy to a time variant voltage level representing the signal. In a preferred embodiment, element 300 is a single omni directional antenna tuned and matched to the frequencies of interest, although element 300 could alternatively include, but is not limited to, a directional planar antenna, a dual element antenna, a directional arrays, and the like.

RF signals may be converted by element 300 as described into a time variant voltage signal which signal may then be fed to element 305 which is preferably an isolator. Note that, using the topology shown in FIG. 2, to form two complete 802.11 clients within two or more respective repeaters 200, an end to end regenerative repeating system may be formed. However, the non-regenerative repeater shown in FIG. 2 and described herein is considered to be more cost effective. Element 305 allows signals to flow from element 300 to low noise amplifier (LNA) 310 and from power amplifier (PA) 325 to element 300 but preferably blocks or isolates LNA 310 from PA 325 as can be understood and appreciated. It will further be appreciated that element 305 could also include but is not limited to a circulator, a directional coupler, a splitter, a switch, and the like as would be known to one of ordinary skill in the art.

As described, received signals maybe fed to LNA 310 for amplification and for setting the noise level. The amplified signal may then be fed to splitter 315 which performs an RF power splitting or coupling function of the signal into two different paths. It should be noted that splitter 315 could also include a directional coupler or any device capable of separating the main received signal into two signals on two paths.

Frequency converters 320 and 321 mix RF signals fed from splitter 315 with signals from local oscillator 340 and 341 to produce an intermediate frequency (IF) signal typically lower in frequency than the RF signal. Local oscillator 340 and 341 are tuned to different frequency such that two different signals at two different frequencies fed from splitter 315 can be converted to a common IF frequency. For example, if two different frequencies, say, F1 at 2.412 GHz and F2 at 2.462 GHz, are present at the input to frequency converters 320 and 321, and, assuming frequency converter 320 is performing a low side mixing function and frequency converter 321 is performing a high side mixing function, then, with LO1 tuned, for example, to 2.342 GHz and LO2 tuned to 2.532 GHz, the outputs from frequency converters 320 and 321 would represent the inputs on F1 and F2 transformed to an IF of 70 MHz.

Each of splitters 323 and 324 operate to separate respective incoming IF signals into two different paths. One of the two paths from each of splitters 323 and 324 couples the respective split signal to delay lines 361 and 360 respectively while the other goes to 366 and 365 respectively. Delay lines 360 and 361 are preferably band-pass filters with delays. Filtering in delay lines 360 and 361 is required to remove all but the desired frequency components from the mixing operation. Additionally, in accordance with various exemplary embodiments, filters associated with delay lines 360 and 361 preferably have sufficient time delay such that the detection and control circuitry can detect which of the two RF frequencies are present and perform control functions to be described hereinafter while signals are delayed therewithin. Alternatively, if truncation of some of the first part of the RF signal is tolerable, then delay lines 360 and 361 would not need specified delays. Bandpass filters (BPF) 365 and 366 in detection and control unit 386 may further perform band-pass filtering without specified long time delays. It should be noted that BPFs 365 and 366 preferably do not require the same level of filtering performance as delay lines 360 and 361.

Power detectors 370 and 371 in accordance with various exemplary embodiments, are preferably simple power detection devices configured to detect whether activity, such as a signal is present on F1 or F2 and provide an output voltage proportional thereto. It will be appreciated that many forms of analog detection may be used for power detectors 370 and 371 including but not limited to, matched filters at RF or IF using SAW devices, matched filters or correlators operating at baseband frequencies after analog to digital conversion, and the like. It will be appreciated that in accordance with various exemplary and alternative exemplary embodiments, power detectors 370 and 371 would be used to demodulate the OOK or other amplitude modulated wave form associated with the management link as described herein above.

Low pass filters (LPF) 375 and 376 are preferably low-pass filters with narrower bandwidths than BPFs 365 and 366. It should be noted that LPFs 375 and 376 are required to remove the high frequency components remaining after detection leaving the power envelope for conversion from analog to digital by converters 380 and 381 which are preferably fast analog-to-digital converters as are known in the art. A digital representation of the analog power envelope remaining after filtering may be generated by converters 380 and 381 and sent to processor 385 which is preferably a microprocessor, digital signal processor, ASIC, or other digital processing and control device, or the like.

It should be noted that in accordance with various exemplary and alternative exemplary embodiments, processor 385 can be programmed to implement software, algorithms, or the like, necessary, for example, in the detection of activity on F1 or F2 within a high degree of certainty, and initiate appropriate control functions. Processor 385, for example, may be configured to use the digitized power envelope information to perform, for example, MODEM functions required to de-modulate the waveform associated with the management link. Such functions may include threshold detection, timing recovery, CRC verification, higher layer protocol functions, and the like. Alternatively, the processor can be eliminated and an exemplary circuit configured with peak detectors with adjustable threshold controls. Digital gates, such as logic circuits or the like, can preferably be configured to generate control outputs to control, for example, the switching and display functions, and logarithmic amplifiers coupled to the output of the low-pass filters, the analog power envelope, to control AGC functions and the like. It should be noted that AGC function, under micro-processor control can be used to perform amplitude modulation in the form of OOK or other, for the transmit oriented functions associated with the management link.

It will further be appreciated that feedback may be useful to indicate certain conditions, such as repeater status conditions, to a user. The provision of user feedback can be controlled, preferably by processor 385, by illuminating indicators 390 which may include, but are not limited to, a series of lamps, light emitting diodes, or the like. Feedback may include an indication, for example, that repeater 200 is in an acceptable location such that frequencies from multiple devices can be detected, that power is supplied to repeater 200, that activity is present, and the like.

Once activity is detected on either F1 or F2, processor 385 controls switches 345 and 355 to allow signal routing. For example, switch 355 is preferably switched to allow the detected signal, either F1 or F2, which signal is at an IF frequency, to be routed to the input of frequency converter 350. Processor 385 further may set switch 345 to allow an appropriate LO signal from either local oscillator 340 or 341 to be routed to frequency converter 350 so that the IF frequency input thereto is translated to the proper frequency for output. As an example, using the frequency in the previous examples, assume F1 is at 2.412 GHz, and F2 is at 2.462 GHz, and the IF is 70 MHz, and the frequency of local oscillator 340, LO, is 2.342 GHz, the frequency of local oscillator 341, LO2, is 2.532 GHz. If F1 is detected and a portion thereof routed through splitter 315 and frequency converter 320 to delay line 361, switch 355 is set to receive its input from delay line 361, which input is F1 translated to an IF of 70 MHz. Since F1 is to be retransmitted at F2 or 2.462 GHz, then switch 345 would be set to derive LO2 frequency at 2.532 GHz from local oscillator 341. The output of frequency converter 350 would thus be a combination of two frequency components LO2-IF and LO2+IF. Since the desired component is LO2-IF, the calculation would be 2.532 GHz−70 MHz or 2.462 GHz which as it can be seen is F2.

Since frequency converter 350 produces the sum and difference of input signals from switch 345 and switch 355, filter 355 is preferably used to remove the undesirable component. Thus, in the example above, the undesirable component is LO2+IF or 2.602 GHZ and filter 335 is preferably configured or otherwise suitably tuned to perform filtering operations to remove undesired frequency. The example can be applied as well, with appropriate substitutions of values, in a scenario where F2 is detected.

It will be appreciated that, in accordance with the above description, a translated and filtered version of the received signal is applied to variable gain amplifier 330 for applying a variable amount of gain under control, for example, of processor 385. Applying gain at this stage is important to ensure that the signal being fed, for example, to PA 325 for output to the air interface is within the target transmit power range as specified by, inter alia, FCC rules. PA 325 outputs the amplified signal to element 305, which as noted above is preferably an isolator, which then outputs the signal to element 300. As can be appreciated, the signal may then be converted back to an electromagnetic field for transmission by element 300.

It should be noted that the above descriptions and attendant example assume particular values for F1 and F2. It is also possible to operate with any value F1 and F2 by moving LO1 and LO2 to different defined channels and checking for power detection at those channels. Once the channels are determined, processor 385 will use those and all operations will be preformed as described above. Control of LO1 and LO2 can be accomplished by processor 385. It should further be noted that frequency translation may be controlled according to a timer, which may be implemented in the processor or can be a timer circuit (not shown). Alternatively, frequency translation may be maintained for the duration of a packet interval associated with a received signal, or may be maintained while activity is detected.

One of ordinary skill in the art will recognize that the AP 100, as noted herein above, may be operatively coupled to any one or a combination of wired or wireless wide area network infrastructure elements through an interface which is typically compliant to a governing protocol and connected using one, or a combination of, the following connection types and/or equipment or equipment types: digital subscriber line (DSL), cable modem, PSTN, Cat5 Ethernet cable, cellular modem, other wireless local loop type system, or the like such as, for example, in accordance with 802.16 protocol.

Further, AP 100, as also noted herein above, may be connected in an ad-hoc peer to peer network configuration where client stations, nodes, devices and the like communicate without the aid of a base unit. An exemplary WLAN, in accordance with various exemplary embodiments, preferably requires that each unit receive and transmit at the same frequency; where the exemplary protocol used therein defines multiple operating frequencies; and where the exemplary protocol includes at least one of the following: 802.11, 802.11b, 802.11a, 802.11g, any additional incremental extensions or evolutions of the 802.11 WLAN protocol, Bluetooth, TDS-CDMA, TDD-W-CDMA.

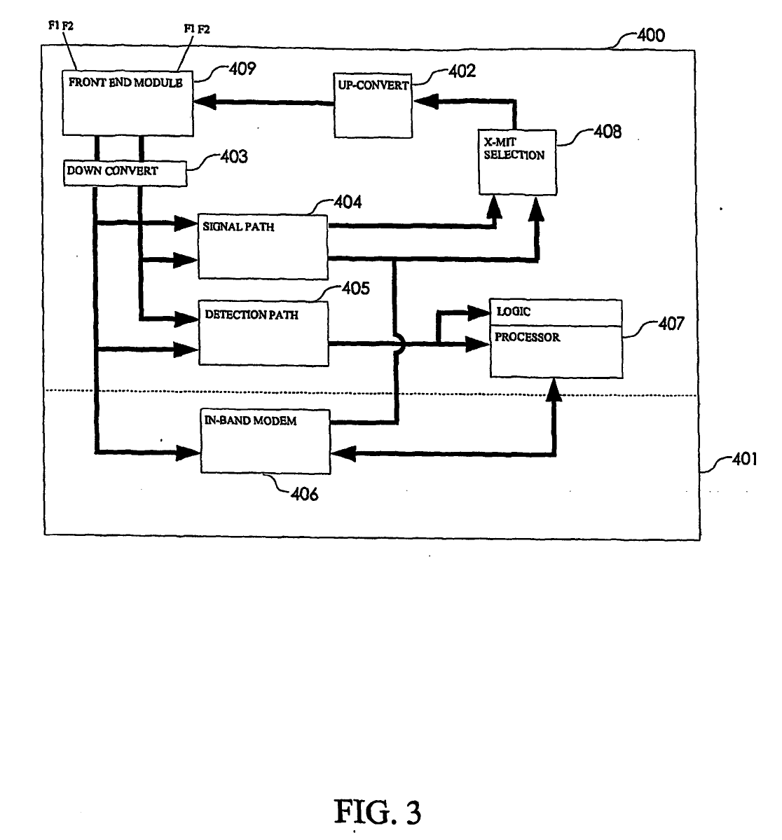

Referring to FIG. 3, block 400 exemplary components related to the functionality in accordance with various exemplary embodiments, of hardware represented, for example, in FIG. 2. Block 401 includes a modem 406 in parallel with, for example, frequency translating repeater 200, having interconnects allowing the in band management link to be realized using modem 406. Analog front end 409 is preferably capable of receiving both F1 and F2, and may further be coupled or otherwise interfaced with down converter 403. Down converter 403 is preferably connected to signal path 404, detection path 405, and modem 406 which as can be appreciated is an in-band modem. It should be noted that down-converter 403 processes the incoming signal to a common intermediate frequency which is then routed through various modules and circuit elements. Modem 406 is preferably capable of processing incoming signals to demodulate the signal to information bits and passing the information bits to processor 407 which, in accordance with various exemplary and alternative exemplary embodiments, can be the same as processor 385 shown in FIG. 2, can be an auxiliary processor working in connection with processor 385, or can be a dedicated processor or the like as would be appreciated by one of ordinary skill. Processor 407 can in turn generate messaging in the form of information bits and pass this information to the modem 406 where modulated waveforms associated with the information bits can be generated and coupled to transmit selection block 408. Transmit selection block 408 is configured to couple the modulated waveform from modem 407 to up-converter 402, which in-turn generates baseband signals and couples the output to RF module 409 for amplification and transmission, for example under the guidance of processor 407 or the like.

It should be noted that in accordance with operation during intervals where frequency translating repeater is in the process of repeating, signal path 404 and detection path 405 operate, for example, as described with reference to FIG. 2. Detection block 405 preferably detects the presence of a packet or signals associated with a packet on F1 or F2 translated to the two inputs thereof, from down converter block 403. When a signal has been detected, transmit selection block 408 is preferably controlled either by processor 407 as noted above, or by combinatorial logic, shown in the diagram illustrated in FIG. 3 as associated with processor 407, and coupled to detector block 405, thus causing the selection of the signal which is preferably present on at least one of the two independent paths of signal path 404. It will be appreciated that the signal is preferably up-converted by up-converter 402 and transmitted as described in FIG. 2.

One of ordinary skill in the art will further recognize that various techniques can be used to configure different modulation methods such as amplitude modulation using gain control, and, for example, different signal detector circuits without departing from the scope of the present invention. Additionally, various components, such as variable gain control 330, processor 385 and functions carried out thereon for implementation of an in band management in accordance with various exemplary embodiments, and other elements could be combined into a single integrated device such as an application specific circuit or the like. Other changes and alterations to specific components, and the interconnections thereof, can be made by one of ordinary skill in the art without deviating from the scope and spirit of the present invention.

The invention has been described in detail with particular references to presently preferred embodiments thereof, but it will be understood that variations and modifications can be effected within the spirit and scope of the invention.

What is claimed is:

1. A method for managing the operation of a frequency translating repeater within a wireless local area network (WLAN) environment, the frequency translating repeater capable of establishing a first radio frequency (RF) link having a first and second frequency channel, the WLAN environment governed by a communication protocol, the WLAN environment capable of having at least another WLAN node compliant with the communication protocol and capable of establishing a second RF link to the frequency translating repeater on either the first or second frequency channel, the method comprising:
establishing a management link with the at least another WLAN node at a higher layer of the communication protocol; and
configuring at least one of the first and second RF link based on a message associated with the communication protocol and transferred on the management link between the frequency translating repeater and the at least another WLAN node.

2. The method according to claim 1, wherein the establishing a management link includes detecting a waveform modulated in accordance with the higher layer of the communication protocol on at least one of the first and the second RF link.

3. The method according to claim 1, wherein the establishing a management link includes modulating a waveform in accordance with the higher layer of the communication protocol on at least one of the first and the second RF link.

4. The method according to claim 1, wherein the configuring at least one of the first and second RF links includes configuring the frequency translating repeater to translate a signal transmitted on one of the first and the second RF link to the other of the first and the second RF link based on the message.

5. The method according to claim 1, wherein the configuring at least one of the first and second RF links includes configuring the frequency translating repeater to translate a signal transmitted on one of the first and the second frequency channel to an other of the first and the second frequency channel based on the message.

6. The method according to claim 1, wherein the configuring at least one of the first and second RF links includes configuring the frequency translating repeater change the frequency of at least one of the first or second frequency channels.

7. The method according to claim 1, further comprising:
monitoring at least the first and second RF links; and
detecting whether a signal is present on one of the at least first and second RF links.

8. The method according to claim 1, wherein the configuring at least one of the first and second RF links includes configuring the frequency translating repeater change transmission power of at least one of the first or second frequency channels.

9. The method according to claim 8, further comprising:
translating the detected signal:
to the second frequency channel if the signal is detected on the first frequency channel of the first RF link for a time interval,
to the first frequency channel if the signal is detected on the second frequency channel of the first RF link for the time interval.

10. The method according to claim 9, wherein the time interval corresponds to a packet interval associated with the signal.

11. The method according to claim 9, wherein the time interval is set according to a timer.

12. The method according to claim 9, wherein the time interval expires when the signal is no longer detected.

13. A frequency translating repeater capable of use within a WLAN environment governed by a communication protocol and capable of having at least another WLAN node compliant with the communication protocol, the frequency translating repeater comprising:
a transceiver section; and
a processor coupled to the transceiver section, the processor configured to:
be capable of establishing a first RF link having a first and second frequency channel, wherein the at least another WLAN node is capable of establishing an RF with the frequency translating repeater
establish an in-band management link with the at least another WLAN node at a higher layer of the communication protocol, and
configure at least one of the first and second RF links based on a message associated with the communication protocol and transferred on the management link between the frequency translating repeater and the at least another WLAN node.

14. The frequency translating repeater according to claim 13, wherein the transceiver section includes a detection circuit to detect a waveform, modulated in accordance with the higher layer of the communication protocol, on at least one of the first and the second RF link.

15. The frequency translating repeater according to claim 13, wherein the transceiver section includes a modulator to modulate a waveform in accordance with the higher layer of the communication protocol, on at least one of the first and the second RF link.

16. The frequency translating repeater according to claim 13, wherein the processor, in configuring at least one of the first and second RF links is further configured to configure the frequency translating repeater to translate a signal transmitted on one of the first and the second RF link to the other of the first and the second RF link based on the message.

17. The frequency translating repeater according to claim 13, wherein the processor, in configuring at least one of the first and second RF links is further configured to configure the frequency translating repeater to translate a signal transmitted on one of the first and the second frequency channel to an other of the first and the second frequency channel based on the message.

18. The frequency translating repeater according to claim 13, wherein the processor, in configuring at least one of the first and second RF links is further configured to configure the frequency translating repeater to translate a signal transmitted on one of the first and the second frequency channel to one of a third and the fourth frequency channel based on the message.

19. The frequency translating repeater according to claim 17, wherein the processor is further configured to:
monitor at least the first and second RF links; and
detect whether a signal is present on one of the at least first and second RF links.

20. The frequency translating repeater according to claim 19, wherein the processor is further configured to:
translate the detected signal:
to the second frequency channel if the signal is detected on the first frequency channel of the first RF link for a time interval,
to the first frequency channel if the signal is detected on the second frequency channel of the first RF link for the time interval,
to the fourth frequency channel if the signal is detected on the third frequency channel of the second RF link for the time interval, and
to the third frequency channel if the signal is detected on the fourth frequency channel of the second RF link for the time interval,

21. The frequency translating repeater according to claim 20, wherein the time interval corresponds to a packet interval associated with the signal.

22. The frequency translating repeater according to claim 20, wherein the time interval is set according to a timer.

23. The frequency translating repeater according to claim 20, wherein the time interval expires when the signal is no longer detected.

24. The frequency translating repeater of claim 13, further comprising an intermediate frequency (IF) unit configured to be capable of:
down-converting a signal on the first RF link; and
selecting one of the first and second frequency channels for connection to the transceiver.

25. The frequency translating repeater of claim 24, wherein the IF unit is further configured to filter the down-converted signal from the one of the first and second frequency channels.

26. The frequency translating repeater of claim 24, wherein the IF unit if further configured to:
delay the down converted signal from the one of the first and second frequency channel during a period when a signal is not detected on an other of the first and second frequency channel, the delay to prevent a loss of at least a portion of the signal.

27. The frequency translating repeater of claim 13, further comprising a diode detector coupled to the transceiver and the processor, the diode detector configured to detect at one of: an IF signal, and a baseband signal.

28. The frequency translating repeater of claim 13, further comprising a matched filter detector coupled to the transceiver and the processor, the matched filter detector configured to detect at one of: an IF signal, and a RF signal.

29. The frequency translating repeater of claim 19, further comprising a converter coupled to the transceiver and the processor, the converter configured to convert the signal to a digital signal and wherein the processor in detecting is further configured to:
compare a power level associated with the signal power associated with the first and the second frequency channel;
determine a noise estimate associated with the power level;
compare the current signal power to this estimate as part of the detection process.

30. The frequency translating repeater of claim 29, wherein the processor in detecting is further configured to:
integrate the power level associated with the signal for a period of time; and
compare the integrated power level to the power level associated with the signal.

31. The frequency translating repeater according to claim 13, wherein the frequency translating repeater includes a non-regenerative repeater.

32. The frequency translating repeater according to claim 13, further comprising a transmit antenna and a receive antenna, and wherein the transceiver is configured to transmit using the transmit antenna and to receive using the receive antenna.

33. The frequency translating repeater according to claim 32, wherein the transmit antenna and the receive antenna have opposite polarizations.

34. The frequency translating repeater according to claim 32, wherein the transmit antenna and the receive antenna are directionally isolated.

35. A non-regenerative frequency translating repeater having a first and a second RF channel, the non-regenerative frequency translating repeater comprising:
a memory;
a processor coupled to the memory, the processor configured to:
receive a signal associated with a data packet on a first RF channel;
translate the signal associated with the data packet to a second RF channel; and
translate the signal from the second RF channel to the first RF channel with no re-generation of the signal; and
a modem coupled to the memory and the processor, the modem configured to control a management link between a wireless local area network and the non-regenerative frequency translating repeater.

36. The non-regenerative frequency translating repeater according to claim 35, further comprising one or more of the following components: a low noise amplifier (LNA), a power amplifier (PA), an up converter, and a down converter, and wherein the modem further includes a client device and wherein the one or more of the components are shared between the non-regenerative frequency translating repeater and the client device.

37. The non-regenerative frequency translating repeater according to claim 35, wherein the modem includes an IEEE 802.11 standard compliant device.

38. The non-regenerative frequency translating repeater according to claim 35, wherein the modem is capable of receiving and transmitting at least a sub-set of messages defined in IEEE 802.11 and derivative IEEE 802.11.

39. The non-regenerative frequency translating repeater according to claim 35, wherein the modem includes a standard client device

40. The non-regenerative frequency translating repeater according to claim 35, further comprising a detector for detecting the signal and wherein the detector is shared between the non-regenerative frequency translating repeater and the modem.

41. The non-regenerative frequency translating repeater according to claim 40, wherein the processor is further configured to demodulate information on the management link using the detector.

42. The non-regenerative frequency translating repeater according to claim 41, wherein the information on the management link is modulated using amplitude modulation of the signal.

43. The non-regenerative frequency translating repeater according to claim 41, wherein the modem is further configured to communicate with one or more of: an 802.11 device, a station device (STA), and a data communications device.

44. The non-regenerative frequency translating repeater according to claim 35, wherein the modem is further configured to communicate with one or more of: an access point (AP), and a repeater.

45. The non-regenerative frequency translating repeater according to claim 44, wherein the AP includes an 802.11 AP.

46. The non-regenerative frequency translating repeater according to claim 44, wherein one or more messages transmitted on the management link include: a MAC address of the repeater, and a MAC address of the access point.

47. The non-regenerative frequency translating repeater according to claim 46, wherein the one or more messages include one or more of the following: a node identification message, an initial configuration message, a configuration modification message, and a performance monitoring message.
